(19) United States
(12) Patent Application Publication
(10) Pub. No.: US 2006/0176275 A1
(43) Pub. Date: Aug. 10, 2006

(54) Input unit for computer or the like

(76) Inventor: Eric Delattre, Villeneuve D'Ascq (FR)

Correspondence Address: YOUNG & THOMPSON, 745 SOUTH 23RD STREET, 2ND FLOOR, ARLINGTON, VA, 22202, US

(21) Appl. No.: 10/564,285

(22) PCT Filed: Jul. 22, 2004
(86) PCT No.: PCT/FR04/01946

§ 371 Date: Jan. 11, 2006

(30) Foreign Application Priority Data
Jul. 23, 2003 (FR) 03/08981

(51) Int. Cl. G09G 5/08

(52) U.S. Cl. 345/163

(57) ABSTRACT

An input peripheral (1) for a computer or the like, includes a movable portion handled by the operator and fitted with electrical sensors suitable for generating electrical signals for sending to the computer in response to movements imparted to the movable portion by the operator, wherein the movable portion includes a shell (4) connected to a stationary base (2) by a movable joint arranged to allow all possible movements of the shell (4) relative to the base (2) with the exception of movement in translation in a direction substantially perpendicular to the support plane of the base (2).

The invention relates to an input peripheral for a computer, usable for manipulating virtual articles on the screen in fields as varied as computer-assisted design (CAD), computer graphics, video games, or medical imaging, and also usable for manipulating real articles such as surveillance cameras, robots, or machines for taking measurements in three dimensions.

### BACKGROUND OF THE INVENTION

A known input peripheral for a computer, commonly known as a mouse, comprises a shell on which the hand of an operator rests and which is secured to a base suitable for sliding over a plane surface. Such a mouse is fitted with electrical sensors suitable for generating electrical signals that are sent to the computer in response to movements of the mouse, enabling movements to be distinguished in two distinct directions, which suffices for most office applications, but which is insufficient for enabling a virtual or a real article to be manipulated in three dimensions, since that requires control with six degrees of freedom.

Input peripherals are also known, e.g. from U.S. Pat. No. 6,333,733, that are constituted by a stationary base and a shell connected to the base via a movable joint allowing the shell three degrees of freedom in translation and three degrees of freedom in rotation relative to the base. The operator moves the shell in three dimensions depending on the movements to be imparted in the article being manipulated, and it is possible to make use of several degrees of freedom simultaneously. The software that responds to the signals from sensors fitted to such an input peripheral is advantageously programmed so that the movements of the controlled articles reproduce faithfully the movements of the shell.

Nevertheless, one of the degrees of freedom corresponds to the shell moving in a direction perpendicular to the support plane on which the base of the peripheral stands. This characteristic prevents the hand from resting on the shell and requires a handrest (i.e. for the heel of the hand) with a wrist extension, which runs the risk of giving rise over time to the musculoskeletal disorder known as carpal tunnel syndrome.

### OBJECT OF THE INVENTION

An object of the invention is to provide an input peripheral that presents the same comfort in use as does a mouse, while allowing a significant number of degrees of freedom to be manipulated.

### BRIEF DESCRIPTION OF THE INVENTION

More precisely, the invention provides an input peripheral for a computer or the like, the peripheral comprising a movable portion handled by the operator and fitted with electrical sensors suitable for generating electrical signals for sending to the computer in response to movements imparted to the movable portion by the operator, in which, according to the invention, the movable portion comprises a shell connected to a stationary base by means of a joint means configured arranged to allow all possible movements of the shell relative to the base with the exception of movement in translation in a direction substantially perpendicular to the support plane of the base.

The shell can then be manipulated with five degrees of freedom corresponding to two degrees of freedom in translation in directions that are substantially parallel to the plane supporting the base, and three degrees of freedom in rotation, which can be made to correspond with the corresponding five degrees of freedom of the manipulated article.

As for the missing sixth degree of freedom, it can be controlled by a control member fitted to the peripheral.

Thus, it is possible to control at least five degrees of freedom of the manipulated article while continuing to support the hand, and while maintaining very instinctive correspondence between the movements of the shell and the movements of the manipulated article.

### BRIEF DESCRIPTION OF THE DRAWINGS

The invention can be better understood in the light of the following description given with reference to the accompanying figures, in which:

FIG. 1 is a longitudinal section view of an input peripheral constituting a first particular embodiment of the invention;

FIG. 2 is a plan view of FIG. 1, with the shell of the input peripheral partially cut away on line II-II of FIG. 1;

FIG. 3 is a view analogous to FIG. 1 showing an input peripheral constituting a second particular embodiment of the invention; and

FIG. 4 is a view analogous to FIG. 1 showing an input peripheral constituting a third particular embodiment of the invention.

### DETAILED DESCRIPTION OF THE INVENTION

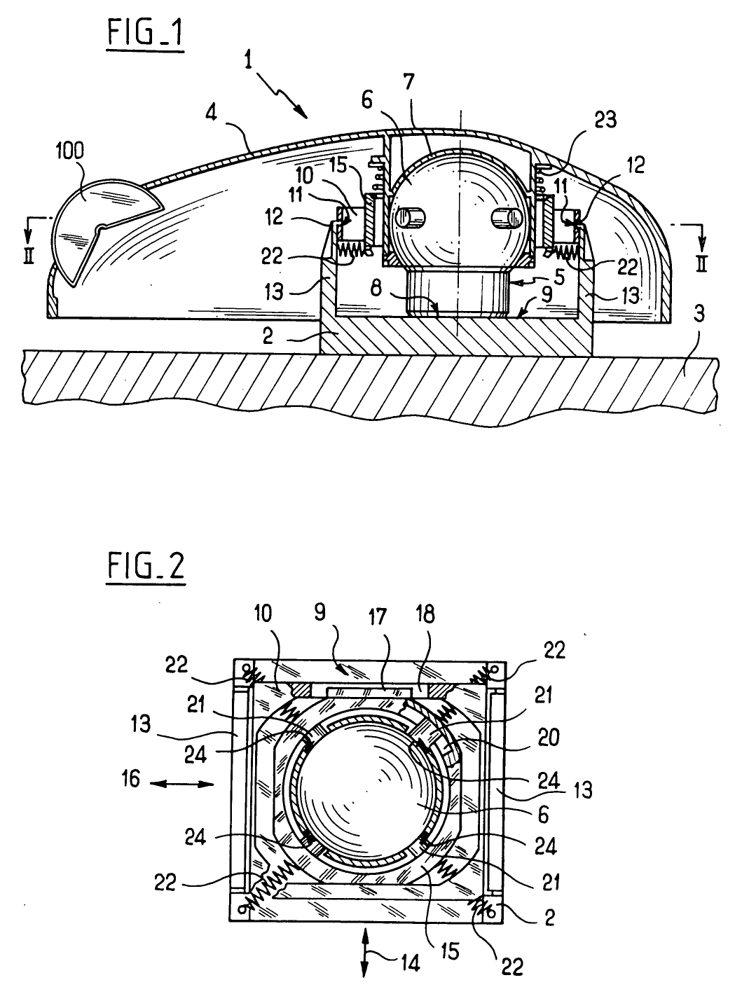

With reference to FIG. 1, the input peripheral 1 of the invention comprises a base 2 placed on a support plane 3, for example the operator's desk.

The input peripheral 1 comprises a shell 4 of ergonomically curved shape suitable for being easy to hold in the hand.

The shell 4 is connected to the base 2 by means of joint means, in this case based on a connection element 5 extending between the base 2 and the shell 4. The connection element 5 has a spherical top end 6 which is received in a complementary spherical cavity 7 in the shell 4, and a plane bottom end 8 which presses against a plane surface 9 of the base 2, in this case parallel to the support plane 3.

It should be observed that the plane surface 9 is parallel to the support plane 3 in this example. In a variant it could extend at an angle relative to said support plane.

Below, the term “transverse” direction is used to designate the direction perpendicular to the plane surface 9.

These dispositions make the following movements possible:

movements in rotation of the shell 4 which can be turned relative to the base 2 under the effect of torque imposed by the operator's hand on the shell 4 about the center of the spherical top end 6 of the connection element 5; and

movements in translation of shell 4 can be displaced relative to the base 2 by application of a force in the plane of the base imparted by the operator's hand, during which displacements the plane bottom end 8 of the connection element 5 slides on the plane surface 9 of the base 2.

The movements in rotation give the shell 4 three degrees of freedom in rotation, while the movements in translation give the shell 4 two degrees of freedom in translation.

It should be observed that a force exerted by the operator's hand on the shell 4 in the transverse direction is transmitted directly to the base 2 by the connection element 5 and leads to no movement of the shell 4. The operator's hand can thus rest on the shell 4, thereby relieving the arm and avoiding resting on the carpal region.

The five degrees of freedom of the shell 4 made possible by the joint means between the shell 4 and the base 2 are advantageously used to represent the corresponding five degrees of freedom of a virtual or real article manipulated by means of the input peripheral of the invention.

As for the sixth degree of freedom, specifically that which corresponds to movement in translation in the transverse direction that is prevented by the joint means, it can be controlled by means of a scroll wheel 100 carried by the shell 4. In this example the scroll wheel 100 is an incomplete sector pivotally mounted on the shell 4 to pivot over a determined range of angles.

In order to measure the movements of the shell 4 relative to the base 2, the input peripheral 1 is fitted with movement sensors that are not shown in order to clarify the figures.

In order to make it easier to measure the movements of the shell, the input peripheral 1 is fitted with auxiliary parts, specifically a first slider 10 and a second slider 15 that make it easier to put the position sensors into place.

The first slider 10 is mounted on the base 2 to slide in the direction 14 (shown in FIG. 2) extending in an equatorial plane of the spherical end 6 parallel to the plane surface 9. For this purpose, and as can be seen in FIG. 1, the first slider has slots 11 receiving tenons 12 carried by uprights 13 secured to the base 2 and extending in register with each other on either side of the plane surface 9.

The second slider 15 is mounted in the first slider 10 to slide in a direction 16 which extends in the above-mentioned equatorial plane, perpendicularly to the direction 14. For this purpose, the second slider has tenons 17 (one of which can be seen in the cutaway view of FIG. 2), that slide in grooves 18 in the first slider 10.

The sliders 10 and 15 do not contribute to defining the joint means between the shell 4 and the base 2. However they can be used to limit the amplitude of the movements of the shell 4 in the directions 14 and 16 by providing abutments between the base 2 and the first slider 10 and also between the second slider 15 and the first slider 10.

The spherical end 6 of the connection element 5 carries studs 21 extending in radial directions contained in the above-specified equatorial plane, with the ends thereof being received in circular grooves 20 in the second slider 15. As a result, the second slider 15 is continuously centered on the spherical end 6 of the connection element 5 and follows the movements thereof.

When the shell 4 is moved, the second slider 15 moves in the direction 16 by an amount equal to the component of the movement of the shell 4 in said direction 16, entraining the first slider 10 so that it moves by an amount equal to the component of the movement of the shell 4 that is parallel to the direction 14.

It should be observed that in order to enable the shell 4 to turn in spite of the presence of the studs 21, the spherical cavity 7 in the shell 4 includes grooves 24 (these grooves are visible in section in FIG. 2, with the clearance between said grooves and the studs 21 being exaggerated), allowing the studs 21 to pass through the spherical cavity 7 of the shell 4, and allowing the shell 4 to move angularly about an axis contained in the above-specified equatorial plane. It should be observed that during a movement in rotation of the shell 4 having a component in the transverse direction, the connection element 5 is turned together with the shell 4. The connection thus established between the shell 4 and the connection element 5 is thus similar to a constant velocity connection between two shafts with coinciding axes.

These dispositions make it easy to put sensors into place for determining the various movements of the shell 4.

It is thus possible to place a movement sensor between the base 2 and the first slider 10, thereby determining the movement of the shell 4 in the direction 14.

It is also possible to place a movement sensor between the first slider 10 and the second slider 15, thus enabling movement of the shell 4 in the direction 16 to be determined.

It is also possible to place a position sensor between the second slider 15 and the end of one of the studs 21, thereby enabling rotation of the shell 4 about an axis perpendicular to the directions 14 and 16 to be determined, i.e. about an axis parallel to the transverse direction.

Finally, two sensors can be placed between the second slider 15 and the shell 4 to measure movements in the transverse direction from which it is possible to determine movements in rotation of the shell about two perpendicular axes extending in the above-specified equatorial plane.

Finally, for the sixth degree of freedom, controlled by the scroll wheel 100, a simple rotation sensor placed on the axis thereof suffices.

It is advantageous to control not the movements themselves, but their speeds. To do this, the software that makes use of the signals from the sensors of the input peripheral is programmed to move the manipulated article at a speed proportional to the difference between an equilibrium position of the shell (or of the scroll wheel) and a displaced position set by the operator.

To define an angular position of the shell, the input peripheral 1 is fitted with helical springs 22 extending between the uprights 13 of the base 2 and the second slider 15. The springs 22 work in traction only and exert a return force on the second slider 15, urging it towards a central position as shown in FIG. 2, where the springs 22 are both exerting the same force and extend substantially in line with each other.

Returning the second slider 15 also leads to the first slider 10 being returned and also the connection element 5, and finally the shell 4. It should be observed that the return force exerted by the springs 22 relates only to the movements in translation of the various items mentioned, and not at all to the movements in rotation of the shell 4 or of the connection element 5.

To complete the return action, a helical spring 23 (shown in FIG. 1) extends between the second slider 15 and the shell 4, with ends held on each of those two items. Rotation of the shell 4 about an axis parallel to the transverse direction applies twisting to the spring 23, while rotation about an axis perpendicular to the transverse direction applies asymmetrical compression to the spring 23. In both cases, the spring 23 exerts a return force tending to return the shell 4 into a position of angular equilibrium. Given the constant velocity connection implemented by the studs 21 and the grooves 24 between the connection element 5 and the shell 4, the return of the shell 4 also causes the connection element 5 to return towards the position shown in FIG. 2.

The springs 22 and 23 thus define a single equilibrium position for the shell, towards which it returns whenever it is not being handled.

Finally, the scroll wheel 100 is itself returned towards an equilibrium position in the middle of its range of angular movements, by means of a simple spring blade (not shown). In a variant, it is possible to provide a torsion spring.

The equilibrium positions of the shell 4 and of the scroll wheel 100 serve to measure a difference between said equilibrium positions and the positions in which the operator puts the shell or the scroll wheel.

It should be observed that the first slider 10 and the second slider 15 are never subjected directly to the force delivered by the operator's hand. In particular, they are not subjected to any transverse force which is transmitted directly from the shell 4 to the base 2 via the connection element 5. The sliders 10 and 15 are subjected solely to drive forces in a plane parallel to the plane surface 9 of the base 2, and to the forces from the return springs 22 and 23. They are therefore subjected to very little stress.

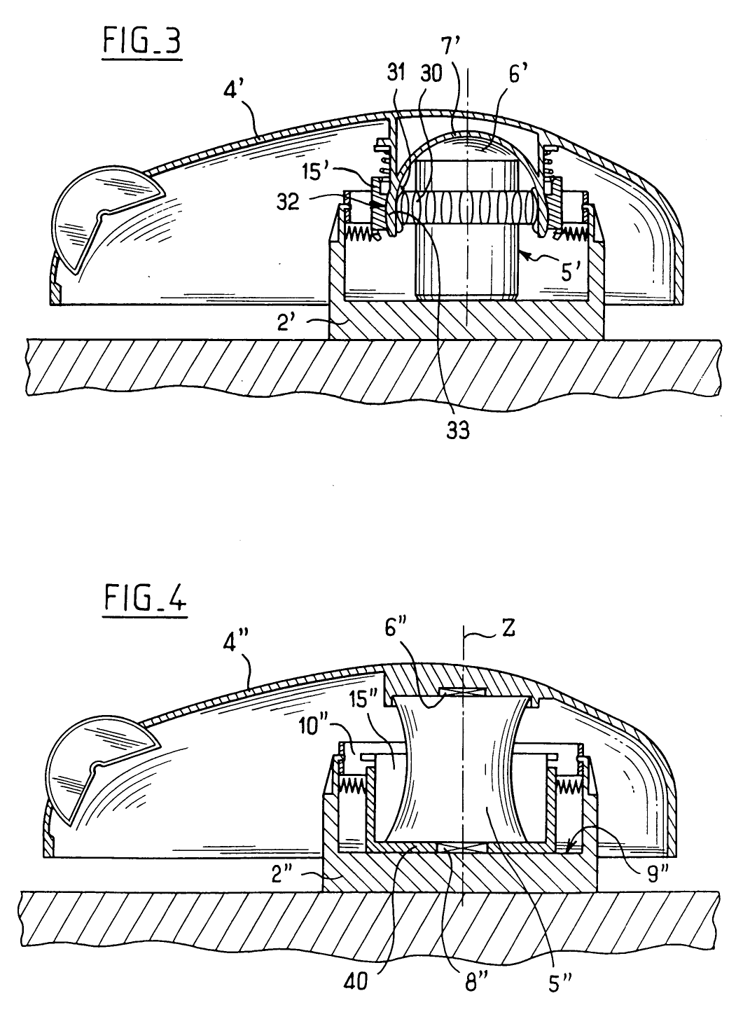

In a second particular embodiment shown in FIG. 3, the connection element 5′ still has a spherical first end 6′ which co-operates with a complementary cavity 7′ in the shell 4′, thus enabling the weight of the hand resting on the shell 4′ to be transmitted directly to the base 2′. However, the studs and the grooves of the above embodiments are replaced by fluting 30 having curved flanks carried by the first end and co-operating with compatible fluting 31 carried by the shell 4′. The fluting 30, 31 provides the rotary connection between the shell 4 and the support element 5 about one axis, while allowing the shell to move in directions contained in the equatorial plane. To center the second slider 15′ continuously on the support element 5′, the second slider 15′ includes a spherical cavity 32 which co-operates with a complementary spherical bearing surface 33 of the shell 4, the spherical cavity and the complementary bearing surface having the same center as the spherical end 6′.

In a third particular embodiment shown in FIG. 4, the connection element 5″ has a waisted shape like a grooved pulley wheel and is made of anisotropic elastomer material that is capable of being deformed elastically under twisting forces about an axis Z of circular symmetry, and under bending forces about axes perpendicular to said axis of symmetry. In this case, the connection element 5″ is disposed in such a manner that the axis Z of circular symmetry of the pulley wheel shape extends in the transverse direction.

The connection element 5″ has a first end 6″ embedded in the shell 4″, and a second end 8″ embedded in a sole plate 40 of the second slider 15″, which sole plate presses freely against the plane surface 9″ of the base 2″. The support element 5″ is thus no longer directly in contact with the plane surface 9″, but remains pressed thereagainst via the sole plate 40, with this providing a connection that allows the connection element to slide on the plane surface 9″, so that the second end of the support element is slidably received on the base in a manner similar to the above embodiments. The shell 4″ can thus be moved in two directions parallel to the plane surface 9″.

Furthermore, the resilience of the connection element 5″ allows the shell 4″ to move along axes parallel to the plane surface 9″, and allows the shell 4″ to move in rotation about the transverse direction, thereby providing a movable joint between the shell 4″ and the base 2″ of the spherical type, similar to that of the above examples.

Overall, the connection element 5″ provides a joint means between the base 2″ and the shell 4″ that permits five degrees of freedom, while still allowing the hand to rest on the shell 4″, with this force being transmitted via the connection element 5″ and the sole plate 40 of the second slider 15″ to the base 2″.

In this respect, it should be observed that the connection element presents a high degree of stiffness in the direction Z, stiffness that is much greater than its stiffnesses in bending and in twisting.

It should be observed that the second slider 15″ is still slidably mounted in the first slider 10″, such that the first slider 10″ prevents the second slider 15″ from turning about the transverse direction, thereby preventing the second end 8″ of the connection element from turning. This disposition makes it possible to organize return of the shell in rotation about the transverse direction, in addition to return during movements of the shell 411 obtained merely by pressing against the ends of the connection element 5″.

It should also be observed that because the end 8″ of the connection element 5″ is embedded in the sole plate 40 of the second slider 15″, the second slider remains permanently centered on the axis Z of the connection element 5″.

The invention is not limited to the particular embodiments of the invention described above, but on the contrary covers any variant coming within the ambit of the invention as defined by the claims.

In particular, although the scroll wheel is shown as being positioned on the shell, it could equally well be placed on the stationary base.

Although the input peripheral is shown as having an independent base, said base could form an integral portion of some other structure, such as a desk top or a keyboard.

Although the return means for returning the shell towards its equilibrium position are shown as being constituted by helical springs, the return means in a variant could be constituted by elastomer elements, for example a tubular element extending between the second slider and the shell.

Although the member for controlling the sixth degree of freedom is shown as being a scroll wheel, it would also be possible to use other control members such as a miniature joystick or indeed a button of the kind used for controlling car windows. The control member could be installed on the shell as shown, or else on the base. Where necessary, other control members could be added for controlling additional degrees of freedom (useful for manipulating the arms of a robot, for example), or for controlling other functions (e.g. selector buttons).

1-12. (canceled)

13. An input peripheral (1) for a computer or the like, the peripheral comprising a movable portion handled by the operator and fitted with electrical sensors suitable for generating electrical signals for sending to the computer in response to movements imparted to the movable portion by the operator, wherein the movable portion comprises a shell (4) connected to a stationary base (2) by means of joint means configured arranged to allow all possible movements of the shell (4) relative to the base (2) with the exception of movement in translation in a direction substantially perpendicular to the support plane of the base (2).

14. An input peripheral according to claim 13, wherein the joint means comprises a connection element (5) having a first end (6) co-operating with the shell (4) to provide a spherical type connection, and a plane second end (8) slidably received against a plane surface (9) of the base (2).

15. An input peripheral according to claim 14, wherein the first end (6) of the connection element (5) is spherical and is received in a complementary cavity in the shell (4).

16. An input peripheral according to claim 14, wherein the first end (6) of the connection element (5) and the shell (4) includes co-operation means to allow the shell (4) to move about an axis contained in a plane parallel to the plane surface (9) of the base, while uniting the connection element (5) and the shell (4) in rotation about an axis perpendicular to said plane.

17. An input peripheral according to claim 16, wherein the first end (6) of the connection element (5) is spherical and is received in a complementary cavity in the shell (4), and wherein the co-operation means comprise studs (21) extending in an equatorial plane of the spherical end (6) parallel to the plane surface (9) of the base, the studs (21) extending through grooves (24) in the spherical cavity (7) of the shell (4) allowing the shell (4) to move in rotation about an axis contained in the equatorial plane.

18. A peripheral according to claim 16, wherein the first end (6) of the connection element (5) is spherical and is received in a complementary cavity in the shell (4), and wherein the co-operation means comprise fluting (30, 31) with curved flanks extending between the shell (4′) and the first end (6′) of the support element (5′).

19. An input peripheral according to claim 14, including a first slider (10) mounted to slide on the base (2) in a first direction (14) contained in a plane parallel to the plane surface (9) of the base (2), and a second slider (15) slidably mounted in the first slider (10) to slide along a second direction (16) also contained in said plane and perpendicular to the first direction (14), the second slider (15) including means (20, 24; 33, 34) for centering it on the support element (5).

20. A peripheral according to claim 14, wherein the support element comprises an anisotropic resilient member (5″) bearing firstly against the plane surface of the base and secondly against the shell, being suitable for bending elastically in directions parallel to the plane surface (9″) of the base (2″).

21. An input peripheral according to claim 13, including return means (22, 23) for returning the shell (4) towards an equilibrium position.

22. An input peripheral according to claim 19, including return means (22, 23) for returning the shell (4) towards an equilibrium position, and wherein the return means comprise helical springs (22) extending between the base (2) and the second slider (15).

23. An input peripheral according to claim 19, including return means (22, 23) for returning the shell (4) towards an equilibrium position, and wherein the return means comprise a helical spring (23) extending between the shell (4) and the second slider (15), and including one end held stationary against the shell (4) and one end held stationary against the second slider (15).

24. An input peripheral according to claim 13, including a member (100) for controlling an additional degree of freedom.
